(19) United States
(12) Patent Application Publication
(10) Pub. No.: US 2024/0230127 A1
(43) Pub. Date: Jul. 11, 2024

(54) System and method for monitoring and analysing a change of sound variables in a closed pressurized unit

(71) Applicant: Applied Sonar AB, Bromma (SE)

(72) Inventors: Martin Sellö, Bergshamra (SE); Madeleine Gustafsson, Stockholm (SE)

(21) Appl. No.: 18/557,309

(22) PCT Filed: May 11, 2022
(86) PCT No.: PCT/EP2022/062821

§ 371 Date: Oct. 26, 2023

(30) Foreign Application Priority Data
May 12, 2021 (SE) 2150609-2

(51) Int. Cl. F24F 11/32; F24F 11/39; F24F 13/24; F24F 140/00

(52) U.S. Cl. CPC F24F 11/32; F24F 13/24; F24F 11/39; F24F 2140/00

(57) ABSTRACT

A system for monitoring and analysing a change or deviation of sound variables within a closed pressurised unit, which system is a system for distribution of gaseous components and which system comprises at least one closed pressurised unit, which closed pressurised unit in turn comprises a flow inducer, at least one device having at least one changeable open area and at least one sound capturing device; a system monitoring device having a database, which database comprises stored reference values for sound variables, which database further comprises values of characteristic variable(s) and/or changeable open area corresponding to the reference sound variables values and which system monitoring device is able to receive values of sound variables and characteristic variables and compare it to the stored values from the database; and a method for monitoring and analysing a change or deviation of sound variables in a system.

The present invention refers to a system and a method for registering a change in a measure of sound variables in a closed pressurised volume. The invention more specifically refers to a system intended to be used in any type of an existing device having an air flow through a changeable area.

### BACKGROUND

Ventilation systems can be constructed in various ways, but the main purpose of the system is to create a comfortable indoor climate and to remove moisture, contaminants, and odours from the room. The air can be supplied to the rooms in a network of ducts and distributed into the room through some type of supply unit. It can further be an air conditioning unit or a pressurised system such as a pressurised floor or wall system.

A flow regulator, for example a damper, valve or mixer box, is normally arranged in a ventilation system, in order to regulate the flow of air that is supplied to the air supply unit. The purpose of the flow regulator is to supply a desired amount of air to the air supply unit. A common problem with these flow regulators, are that they tend to generate unwanted sound and also causes a pressure drop. It is also difficult to regulate the amount of air in a more precise way.

Noise, or sound, occurs naturally in any type of ventilation system using a fan. The fan can be a central fan or a local fan in an air conditioning device or air cleaner. This sound will change character when the air passes through different pressurised volumes or other passages. These passages can be a part of a bigger system of air ducts or can be a detail in a product. Many systems are provided with sound silencers (active or passive silencers may be used) or noise dampening material that will change the noise.

In some systems a filter is used in the ventilation system to purify the supply air. The filter must be replaced regularly, both for hygiene reasons but also because clogged filters do not work effectively. If the filters are not changed when clogged, the system will be less efficient because the resistance increases through the filter. In order to keep the same air flow, the fans must work harder, which means that they use more energy and causes more unwanted noise. When the filter gets more and more clogged, during time, the noise through the filter will change.

The system is most often provided with mechanical regulation of the magnitude of the air flow and the direction of the air flow, for example a dampener or other type of regulating device. These devices cause a change in the natural air flow and will also cause turbulence which in turn will amplify the noise travelling with the air. The air supply unit is for example provided with some type of openings where the air enters the room. The magnitude of the air flow can in this way be regulated through a choice of the number of openings that are active and through which air flows. This can be done in many ways for example by using a device having nozzles or other types of openings where at least the size of the openings can be changed mechanically either manually by a user or automatic/electronic by utilizing a motor/engine. One such possible device is described in PCT/SE2019/050173 where a device for regulating an air flow is described, where the magnitude of the air flow can be regulated with a device comprising two cooperating flow guiding means where the size of the openings is adjusted without affecting the direction. Other examples of devices having nozzles used to adjust the magnitude of the air flow are described in U.S. Pat. No. 3,364,841, EP 2498016, JP 3460006 and JP 2005105792A. Other common devices used to regulate the air flow is adjustable discs, lamellas and conventional dampers. All of these examples comprise openings that will also give rise to unwanted noise when the air passes through and out of them. Openings in ventilation equipment will also give rise to noise (both audible and non-audible) when the air passes out of the pressure box. Additional noise is also added in connections between the pressure box and the duct system and in edges and bends in the system when turbulent air flow occurs. Filter used in HVAC (heating, ventilation, and air conditioning) products or air conditioning units changes over time, the open area in the filter decreases due to for instance pollutions and therefore changes the open area naturally.

There are today devices with air openings having an adjustable area, a problem with these is that they generate more noise when they decrease in size, as the pressure drop increases and so does the speed of the air. This also applies when a fan can push more air through openings with a fixed area. There is therefore a need for a system which can counteract or neutralise generated sound so that the total sound from the system is minimised.

Sound variables will change in different parts of the system and product, the pressure inside a product will for example increase when a flow inducer increase the effect. The data variables will also change if the flow inducer have a constant pressure but different dampers and/or regulating devices have different settings, or if for example a filter is clogged somewhere in the system.

The efficiency of a filter or e.g., a heat exchanger connected to the pressure box further decreases as cavities or gaps connected to filters and heat exchangers decrease in efficiency when dirt and particles collect there during use.

There are solutions on the market today for measuring a flow in a ventilation product by ultrasound in a fixed opening or in a duct, such as for example WO2010/122117, which describes a system where ultrasonic flow measurement is used to decide humidity and temperature of the air flow with the aim of lowering energy consumption. However, problems arise in these systems if, for example, a heat exchanger or a filter that induces the air becomes clogged, as the effectivity of the function is reduced even when a correct air flow is measured. This is typical for products with induction function, that cause air to go through a heat exchanger or a filter, before it supplied back to the room.

A measurement of the airflow into the product (from the air duct) will in this case not indicate that the function is decreased even if the open area of the heat exchanger or the filter has decreased.

There are also systems used for providing a fault diagnosis system in ventilation systems such as JP4394893B2. The system described therein is a failure diagnosis system that diagnoses the equipment state of an air conditioner from the outside of the device using the sound generated from the air conditioner. This system however requires a service engineer and a service car to go to the ventilation system and the diagnosis is performed by a computer in the car. This system also only detects a changed sound in the fan, other parts that could affect the sound variables is not monitored or calculated.

It is an object of the present invention to provide a system and a method for monitoring changes in the open area (which for example can be either a filter or openings or a combination of both) by measuring a change in sound variables in the system. It is a further object to provide a system that can monitor several characteristic variables inside an air ventilation unit using only one measuring point.

Other existing systems with fans and mufflers, with integrated microphones and speakers that record and transmit different types of sound frequencies to reduce infrasound and audible sound have several problems. These systems increase pressure drops, for example, and energy losses occur as they are often mounted in complex ventilation systems far away from the end product and the user. Noise and rumble can thus occur later in the system that are not registered. The present inventor(s) realised that the possibility to monitor sound, and changes to the sound, in the ventilation system can be used to monitor a change in an open area. This will make it possible to know if for example a filter needs to be changed or if the air flow suddenly changes without external influence.

EP 3650773 describes a device for measuring clogging of a filter in air-conditioning equipment using sound pressure and a flow controller. This solution is solely focused on delivering a number/factor related to the clogging of the filter. The airflow is measured with a conventional flow controller. The system described in EP 3650773 also requires more parts within the unit which can affect the overall sound within the system.

The present inventor has found that the system and method described herein can be used to both measure and analyse a possible clogging of a device, analyse if an unwanted change of an air flow occurs, measure and analyse changes in sound and to analyse what the cause of the change is. It is further possible to analyse where in the system the problem is and also to be able to measure and analyse characteristics values. The system according to the present description is also able to learn and build up a database with new values and possibly also the cause of the new value.

None of the prior art documents, known to the applicants, indicates that sound capturing devices can be used to monitor and analyse changes in sound in a ventilation system. Thus, the prior art does not describe or suggests that sound capturing devices are placed in a ventilation system to monitor and analyse changes in an open area and/or in air characteristic values and thereby increase effectivity in ventilation systems and decrease unwanted sounds.

None of the systems in the prior art measure change over a changeable open area in a pressurised system and can hence not monitor the effect of the open area changing.

It is an object of the present invention to provide a system and a method for monitoring and analysing a change of sound variables before, over and/or after one or more changeable open areas in a closed pressurised unit. At least some of the embodiments described within the present description makes it possible to analyse and monitor a change over each changeable open area within the system.

### SUMMARY OF THE INVENTION

The present invention provides a system for monitoring and analysing a change or deviation of sound variables within a closed pressurised unit. The system according to the present invention is a system for distribution of gaseous components. The system comprises at least one closed pressurised unit and a system monitoring device connected to a database. The closed pressurised unit in turn comprises a flow inducer, at least one device having at least one changeable open area and at least one sound capturing device. The database comprises stored reference values for sound variables, values of characteristic variable(s) connected to the gaseous components and/or the changeable open area corresponding to the stored reference sound variable values. The system monitoring device is able to receive values of sound variables and characteristic variables and compare it to the stored values from the database. In another embodiment of the system, the flow inducer and the at least one sound capturing device are provided on each side of the device having a changeable open area.

In a further embodiment the system further comprises at least one sound generating device, which sound generating device is provided to emit sound of different frequencies.

In another embodiment of the system, the system further comprises two sound capturing devices, wherein the first sound capturing device is provided on one side of the device and the second sound capturing device is provided on the other side of the device.

In a further embodiment of the system, the system is further provided with two sound generating devices, wherein the first sound generating device S1 is provided on one side of the device and the second sound generating device is provided on the other side of the device. The changeable open area in the system according to the present invention can be changed mechanically.

In a further embodiment of the system, the system comprises at least two devices, each one having at least one changeable open area.

The system according to the present invention is preferably a system for distribution of gaseous and the characteristic variable(s) is characteristic variable(s) connected to the gaseous components in the system. The gaseous component can be any gaseous compound, but is preferably air.

The present invention further provides a method for monitoring and analysing a change or deviation of sound variables in a system as described above, wherein the method comprises the following steps:
i. the first sound capturing device detects sound variables in the closed pressurised unit 1;
ii. the detected sound variables is emitted by the first sound capturing device to the system monitoring device;
iii. the system monitoring device receives the sound variables and compare it to the stored reference sounds in the database; and
iv. the database returns a positive response to the system monitoring device if the detected sound corresponds to a reference sound and a negative response to the system monitoring device if the detected sound deviates from the stored values in the database.

The method can further be provided with one or more of the following steps. In each case a positive response will save the characteristic values in the database while a negative response will trigger the system to move forward to another analysing step:
v. the system monitoring device analyses if the open area has been changed and returns a positive response if the open area has been altered and a negative response if the open area has not been altered;
vi. analysing if any of the characteristic variables has changed, and returning a positive response to the system monitoring unit if any of the characteristic variables have been altered and a negative response if none of the characteristic variables have been altered;
vii. checking the value of the altered sound variables and store it in the database together with a value for the open area and the characteristic variables;
viii. checking the value of the altered sound variables and sending a signal to a user, a system monitor, a building management system, a screen or other device capable of receiving the signal that there is a deviation and give the possibility to manually store the altered sound variables together with a reason for the deviation;
ix. analysing the reason for the deviation by generating a sound using the first sound generating device and detecting the sound in the first sound capturing device and storing the value of the characteristic variables, the open area and the sound variables in the database together with the reason for the deviation;
x. analysing the change of sound variables before and after the at least one changeable open area and calculating the difference in sound variables between the first sound capturing device and the second sound capturing device and automatically storing the value of the sound variables, the characteristic variables, and the open area and in the database together with the reason for the deviation;
xi. generating a first sound in the first sound generating device and generating a second sound in the second sound generating device and comparing the sound received in the first sound capturing device and the second sound capturing device respectively to further increase the accuracy of the analysis performed in the system monitoring unit;
Any of the steps in the method can further be provided with an additional step to indicate a negative response by sending a signal to a user, a building management system, a computer, a screen or other device capable of receiving the signal to notify that there is a deviation in the measured sound variables of the system.

### BRIEF DESCRIPTION OF DRAWINGS

FIG. 1A is a schematic view of one embodiment of the system comprising one sound capturing device

FIG. 1B is a schematic view of a second embodiment of the system comprising one sound capturing device and one sound generating device

FIG. 1C is a schematic view of a third embodiment of the system comprising two sound capturing devices and one sound generating device

FIG. 1D is a schematic view of a fourth embodiment of the system comprising two sound capturing devices and two sound generating devices

FIG. 2A is schematic view of a first embodiment of the system, where the system is provided with one device having a changeable open area

FIG. 2B is a schematic view of a second embodiment of the system, where the system is provided with one device having a changeable open area

FIG. 2C is a schematic view of a third embodiment of the system, where the system is provided with two devices having changeable open areas

FIG. 2D is a schematic view of a fourth embodiment of the system, where the system is provided with two devices having changeable open areas

FIG. 2E is a schematic view of a fifth embodiment of the system, where the system is provided with three devices having changeable open areas

FIG. 2F is a schematic view of a sixth embodiment of the system, where the system is provided with three devices having changeable open areas

FIG. 3 is a flow chart illustrating the steps performed by the system for monitoring sound variables.

FIG. 4 is a flow chart illustrating the steps performed by the system for monitoring sound variables and analysing if a change of the open area has occurred.

FIG. 5 is a flow chart illustrating the steps performed by the system for monitoring sound variables and analysing a deviation.

FIG. 6 is a flow chart illustrating the steps performed by the system for monitoring sound variables and analysing the deviation.

FIG. 7 is a flow chart illustrating the steps performed by the system for monitoring sound variables, analysing the deviance and notifying the deviation.

FIG. 8 is a flow chart illustrating the steps performed by the system for monitoring sound variables, further analysing the deviation using a sound capturing device.

FIG. 9 is a flow chart illustrating the steps performed by the system for monitoring sound variables, further analysing the deviation using a second sound generating device and notifying the deviation.

FIG. 10 is a flow chart illustrating the steps performed by the system for monitoring sound variables, further analysing the deviation and utilise the effects of combining the information from the sound capturing devices and the sound generating device.

### DETAILED DESCRIPTION OF THE INVENTION

The present invention relates to a system for monitoring, and in some embodiments analysing a change of sound variables over an open area inside a closed pressurised are. More precisely it relates to a system where sound capturing device(s) is utilised to monitor a change in sound variables over an open area and the measured values is entered into a database where they can be compared to stored reference values. The database further comprises values of characteristic variables and open area connected to the measured sound variables, whereby it is possible to know if the sound variables match the expected values of the characteristic variables and open area or not.

The system is preferably a system for distribution of gaseous components but can also be used for fluid components. Within this application, gaseous components (or gas) comprise, but are not limited to, air. and fluid components (or fluids) comprises water but could also be other fluids.

Within this application sound or sound variables is used to define different sound variables. Sound can be measured and collected in different sound variables. The sound variables are being collected by one or more sound capturing devices.

Examples of sound variables are: (could be used stand alone or in combination)
Wavelength, phases, velocities, amplitudes, intensity, frequency, motions, stages, pitch, envelope (changes over time), duration
Volumes, pressure, density,
Direction
Quality, timbre
Damping factors

All these are known variables that are familiar in the science around describing different sounds. A person skilled in the art could also find other examples of variables (other than described herein) that are used to defined sound and that can be measured with a sound capturing device.

Examples of characteristic variables are (could be used stand alone or in combination) for volumes/areas of liquids and gases are:
Speed, velocity, vector
Mass concentration, weight,
Pressure
Turbulence
Temperature, humidity
Combination of gases

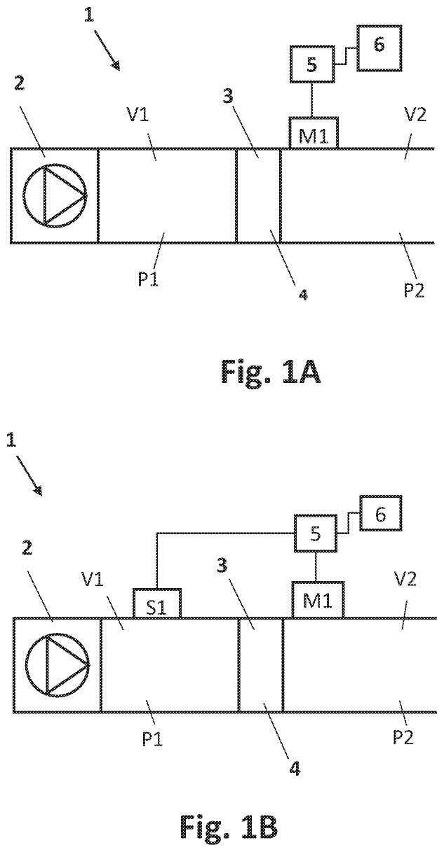

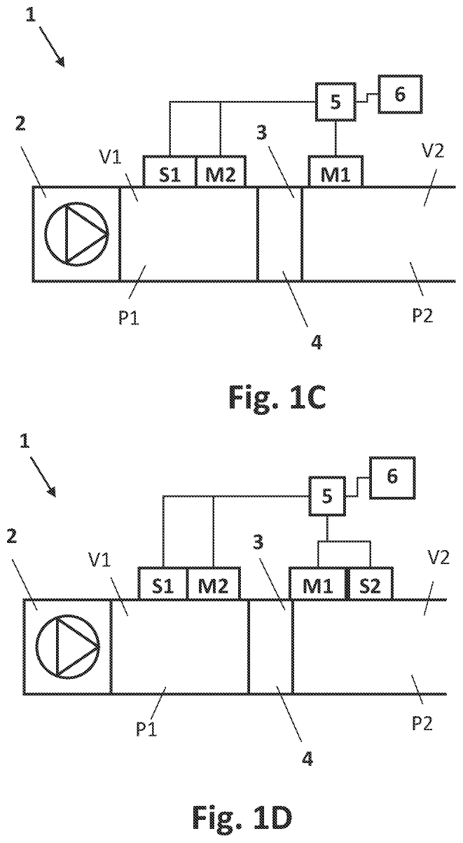

FIG. 1A shows a schematic view of a system for monitoring and analysing a change in one or more sound variables within the system, which system comprises a closed pressurised unit 1, which unit 1 comprises a flow inducer 2, a device 3 and a first sound capturing device M1; a system monitoring device 5; and a database 6. The device 3 comprises at least one changeable open area 4. FIG. 1A also shows a first volume V1 between the flow inducer 2 and the device 3, which volume V1 has a pressure P1 described further below, and a second volume V2 after the device 3, which volume V2 has a pressure P2.

The closed pressurised unit can for example be a ventilation unit, an airduct, an air conditioning device, a water pipe, or other device having a local fan and a pressurised volume. Each volume (V1, V2, V3 etc) as described within this application is a part of such unit, before or after the different components of the system as described of each of the figures. The pressurised unit comprises a flow inducer 2 which creates a flow over the changeable open area 4 having a pressure P. When the changeable open area is decreased, the pressure P1 in an area between the flow inducer and the device 3 will increase and the pressure P2 after the device 3 will decrease. In the same way, when the changeable open area is increased, the pressure P1 in an area between the flow inducer and the device 3 will decrease and the pressure P2 after the device 3 will increase. Each component added to the system, such as a filter, a valve, a damper, a regulator, a heat exchanger etc. will alter the pressure inside the system. The direction of the generated flow is from volume V1 to volume V2 and so forth (V3, V4 etc)

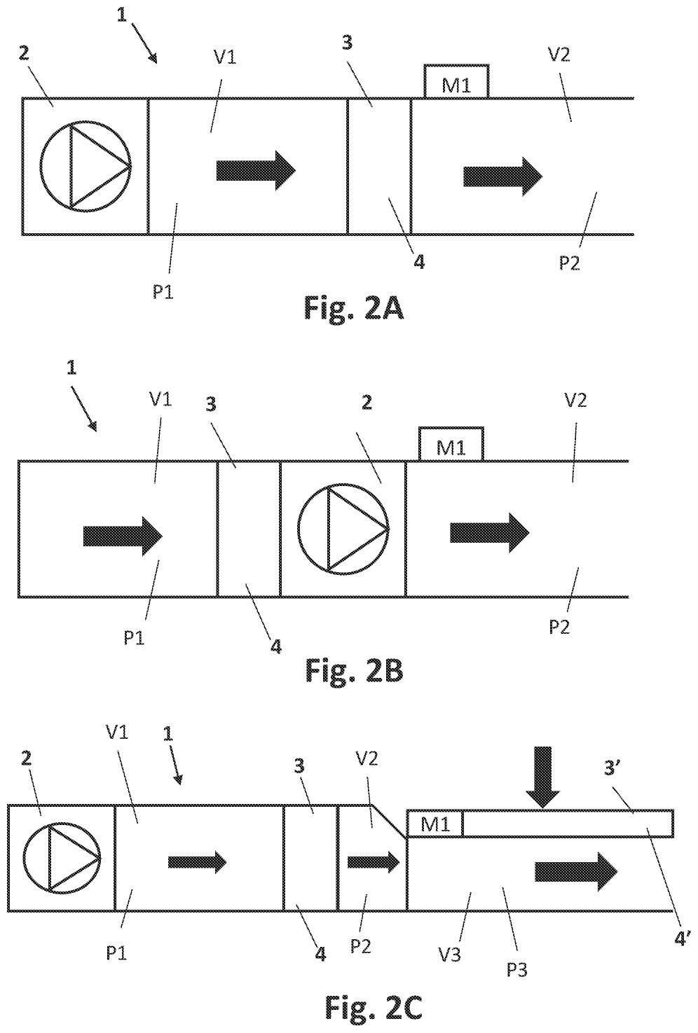

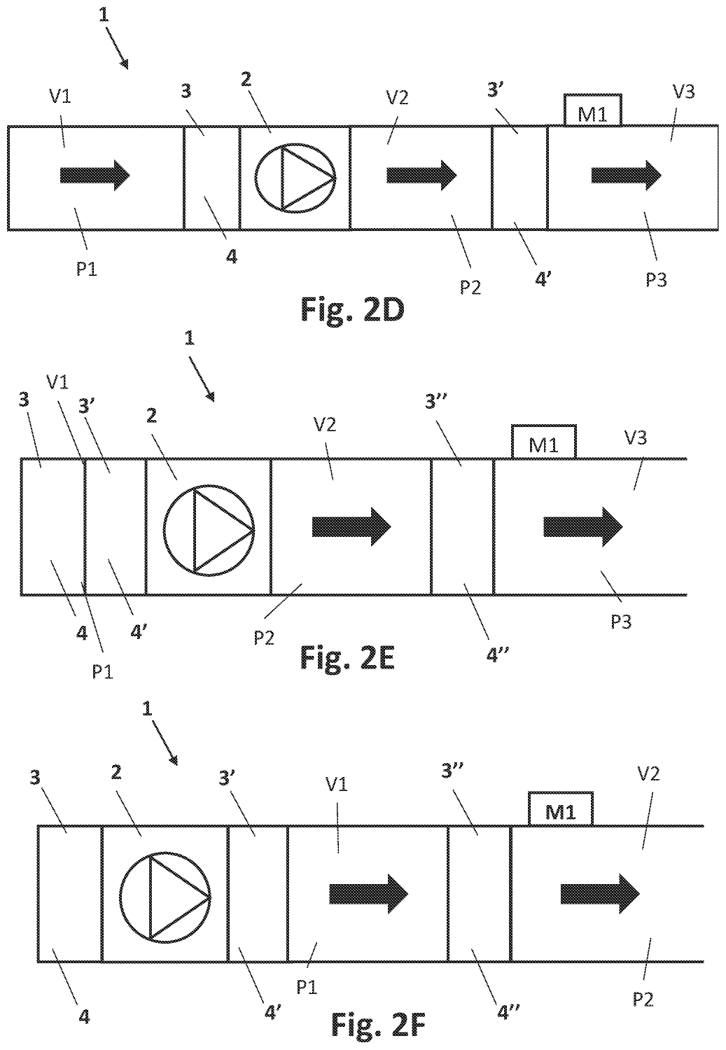

In a system where the flow inducer is placed in the beginning of the unit, as in FIGS. 1A-1D, 2A and 2C the pressure P1 will be higher in the volume V1 compared to the pressure P2 in the volume V2 which will in turn be higher than the pressure P3 in the volume V3 and so forth for each component. The reduction of the pressure is often called pressure drop and is created by the reduction of the open area positioned between two volumes (for example V1 and V2).

The capacity and initial data is received from the manufacturer and a person skilled in the art is well aware of the laws of affinity which can be used if necessary, to calculate for example the effect and/or speed for the flow inducer.

In the case where the system is a system for gaseous components, this description will use air as an example of the gaseous component, but it is to be noted that also other gaseous components could be used. The flow inducer creates a flow within the unit 1 and can for example be a fan, a compressor or other type of device with the ability to draw a gas or a fluid in and increase the pressure of the gas/fluid after the flow inducer. The flow out of the flow inducer can be changed either manually by a user, by the monitoring device or any other appropriate means to change the flow in a flow inducer. The monitoring device could for example be provided with a schedule that will change the magnitude of the flow out of the flow inducer during the hours of the day. If the system for example is a ventilation system in an office building, it will normally have a different need for ventilation during the day than during night and also different to a system in a home environment. In the same way—if the system is provided in a water pipe, the need for water flow varies during the hours of the day in different systems. This is normally individual for each location and system and will hence be adapted according to the intended use. The flow inducer, as well as any component that is a part of the system, causes a basic sound within the system, the sound variables from all components in the specific system used is called the basic sound variables within this application.

The sound variables values of the system are the different sounds that the capturing device register. The sound variables or sound variables value(s), as used herein, is intended to be any type of sound wave, both sound that is audible to humans and sound that is non-audible to humans.

In the case where the system is a system for fluid components, this description will use water as an example of the fluid component, but also other systems with fluids can be used.

The device 3 comprises a changeable open area, which can be changed mechanically or naturally, like for a filter or a heat exchanger. The changeable open area can for example be a device having nozzles or other types of openings where at least the area of the opening(s) can be changed mechanically either manually by a user or automatic/electronic by utilizing a motor/engine. When the number of openings that are open changes or when the area of the opening changes, the air flow out of the system will change, and the sound variables in the system will therefore also change. The device 3 having a changeable open area 4 can also be a filter device or a damper. A damper or a regulator is a valve or plate that stops or regulates the flow of air inside a duct, chimney, VAV box, air handler, or other air-handling equipment. These alternatives are further described with reference to FIG. 2A-F below.

When the open area 4 changes, i.e., the filter is clogged and/or the openings are changed so that the air flow out of the system is higher or lower, the sound variables in the system will change. The open area for a filter is 100% when the filter is first placed in the system, and decreases naturally with time as pollutants, dust and other particles clogs the filter. In embodiments where the open area is a damper or an air regulating device, the value of the K-factor is at different settings known from the manufacturer.

The flow over an open area can be calculated using the formula:

$$Flow = κ - factor \times \sqrt{pressure}$$

For a system with air, the formula is:

$$Air flow = κ - factor \times 1 , 2 \sqrt{differential pressure}$$

The airflow is used in litres per second and the pressure in Pa.

This formula makes it possible to calculate any flow over an open area, using known variables. The system and method as described herein makes it possible to add also other known sound variables, which are unique to each value and change connected to the equation above. It is hence possible to calculate both the airflow, K-factor and differential pressure by using sound variables obtainable from the system.

In a system where the open area is a mechanically changeable open area, the open area can be monitored, for example by the system monitoring unit, and it is possible to always know if and how much the open area has changed. When the open area is a filter it is not always possible to obtain a value of how much the open area has changed, but it is possible to see how the sound variables through the filter changes and thereby possible to know when the open area changes. The sound capturing device M1 can be a microphone or other appropriate device to hear and collect sound of different frequencies. The sound capturing device is used to detect sound inside the system and sends detected sound to a system monitoring device (described further below). The sound capturing device can detect sound continuously or can be set to only detect sound at certain time intervals. A system that continuously detects sounds will consume more electricity than a system that only listens occasionally.

This can be chosen for each system and adapted for the intended use. The sound capturing device can be chosen to suit different systems depending on environment and frequencies that is necessary to detect and monitor. The sound capturing device is preferably placed inside the closed pressurised unit 1 but can also be placed in the wall of the unit 1 or another appropriate place. It is important to place the sound capturing device so that the sound that is measured is primary the sound inside the unit 1. If the sound capturing devices are placed so that the measured sound also covers sound from outside the unit, the measurements and analyses can be erroneous for the purpose of this invention. The device as described herein will therefore have the possibilities to filter sounds that will be erroneous.

In this embodiment, the flow inducer 2 and the at least one sound capturing device M1 is provided on each side of the device 3. This is preferred because the accuracy in the measured characteristic values will be best when the sound capturing device is placed in close connection to the open area. It is however possible to place the sound capturing device in other places in the system, as shown below in other embodiments. This will however potentially require more sources for the database to compare the reference sound with. Complex system with several devices will for example require more sound capturing devices to be able to give detailed information of each device. Side in the sense of this application is intended to refer to before or after a component in the system, as shown in the accompanying figures, and is used in the same way throughout the description.

The task of the sound capturing device(s) is to listen to sound variables that pass through the device(s) inside the unit. It will be able to record characteristic values before, over and after the unit 3 comprising an open area 4.

The system can further be provided with 2, 3, 4 or more sound capturing devices if required. A larger system can advantageously be equipped with several sound capturing devices in order to be able to obtain more accurate measurement values in different parts of the system. This is further described below.

The flow inducer and the at least one sound capturing device can be provided on each side of the device 3 or on the same side of the device 3, and hence the open area 4. When the flow inducer is placed before the device 3 in the flow direction of the gas in the system and the sound capturing device M1 is placed after the device 3 in the flow direction of the gas in the system the system will give more accurate values, since there are fewer other parts in the system that will affect the detected sound in the sound capturing device M1.

The system further comprises a system monitoring device 5 and a database 6. The system monitoring device receives the detected sound from the sound capturing device and checks the value with stored reference values in the database. The monitoring device and the database can be connected to more than one pressurised unit. The system monitoring device can comprise more than one database, for example databases from different systems within a building.

The database 6 have been provided with known sound variables for the basic sound for the system that is used. Each component in the unit 1 have a basic sound. The unit 1 can be adapted to include one or more of the different components (as described further below). Once the system has been installed, the basic sound for the entire unit 1, as well as for each of the components included in the unit can be measured and used as a basic sound in the database. The system will be tested with different air flows, different open areas and different characteristic values to build up a starting point for the database. For example, the flow inducer will be set to different air flow magnitudes so that different sound variables can be directly connected to an air flow. After that, the open area in unit 3 will be altered to receive sound variables for different open areas in the system, and so on for other characteristic variables. This can be done either once the system has been installed, or can be done before installation, in a laboratory environment, in a computer system or other appropriate system.

Within this application the expression “characteristics variable(s)” are used to define the variables of the gas or the liquid in different parts of the system.

The system and method described herein can be utilised both for gaseous systems (typically an air system) and liquid systems (typically water containing systems).

If the system is a system for gaseous components, the characteristics variables comprise at least flow, velocity, volume and pressure, but also other variables can be added to the expression “characteristics variables” such as turbulence, moisture, particle content, gaseous content and electric charge. The characteristic values can be collected from individual components in the system/product but also using a central fan if the system is connected to such. If any of these characteristic values changes, the emitted sound will change and the sound capturing device will be able to detect that there is a deviation in the system.

For air systems, the characteristic values comprise, according to above, at least air flow, air velocity, air volume and air pressure, but also other variables such as turbulence, moisture, particle content, gaseous content and electric charge can be monitored if required.

If the system is a system for fluid components, the characteristics variables comprise at least flow, pressure and velocity, but also other variables such as turbulence, pressure drop, fluid components, water temperature etc can be monitored in the system.

The database is also provided with sound variables for different open areas in the device 3. This is pre-entered values that are known to the system from the beginning. The system monitoring device also continuously monitors the flow out of the flow inducer 2 and the pressure inside the closed pressurised unit 1.

Since the database is continuously updated with new values when anything in the system changes, the database will be more accurate the longer the system is used.

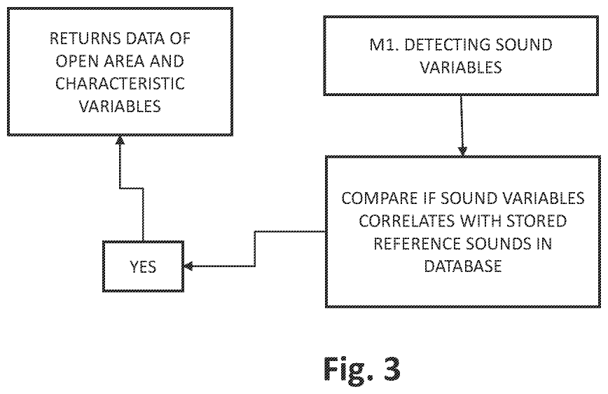

As described above, the flow coming out of the flow inducer will have basic sound variables when passing through the device 3 having a changeable open area. The changeable open area can have different degrees of open area, corresponding to different sound variables that are stored in the database. When the open area changes, the sound wave reaching the sound capturing device will not correspond to the stored reference sound variables value corresponding to the outgoing flow from the flow inducer. This will be an indication that something has changed, and the monitoring device will then be able to notify a user or other parts of the system (described further below with reference to FIGS. 3-10) that there is a deviation.

FIG. 1B shows a schematic view of a system, which system, in addition to the flow inducer 2, device 3 having a changeable open area 4, the first sound capturing device M1, the system monitoring device and the database as described for the system shown in FIG. 1A above, further comprises a first sound generating device S1. The sound generating device S1 can for example be a loudspeaker or other appropriate device to emit sound of different frequencies.

The sound generating device S1 is preferably placed inside the closed pressurised unit 1 but can also be placed in the wall of the unit 1 or another appropriate place. It is important to place the sound generating device S1 so that the sound that is emitted passes through the device 3, it is therefore placed before the device 3 in the flow direction of the air in the system.

The purpose of the sound generating device is to emit sound that passes through the device 3 and then can be detected by one or more sound capturing device(s) on the other side of the device 3. This can be used to help the analysing a change of the open area 4 to be able to analyse the reason for a change of sound variables in the system.

A change in the measured sound indicates that something in the system has been changed, either knowingly or unknowingly, it could either be that the flow of air has changed or that at least one open area has changed. The open area can either be an open area in the wall of the air duct/valve or a filter that is placed in the air duct, or a combination of both.

A change in the sound of the system that is a result of an intentional change of any of the components in the system, either manually by a user or by the system, is defined to be a change. A change in the sound of the system that is not intentional is defined to be a deviation.

By combining the monitoring of sound variables with a database having values of open area and characteristic values such as air flow corresponding to different reference values of sound variables, it is possible to monitor when, primarily unwanted or unplanned changes occur in the system, but also to build up the database by monitoring planned and known changes in the system. The system is self-learning by the addition of new values every time a change or a deviation occurs. As explained further below with reference to the method, the database will be provided with more data the longer the system is used. Data can be added manually or automatically, for example by utilizing the sound generating device S1.

The sound generating device is preferably set to emit sound that does not pass out of the system so that it is not heard on the outside.

The system can further be provided with 2, 3, 4 or more sound generating devices if required. A larger system can advantageously be equipped with several sound generating devices in order to be able to obtain more accurate measurement values in different parts of the system. This is further described below.

In systems comprising one sound generating device and more than one sound capturing device, each sound emitted from the sound generating device can be detected in each sound capturing device.

In systems comprising one sound capturing device and more than one sound generating device, the sound emitted from all sound generating devices can be detected by the sound capturing device.

In systems comprising more than one sound capturing device and more than one sound generating device, each sound capturing device can detect emitted sound from all sound generating devices.

As in the system described in FIG. 1A the first volume V1 is between the flow inducer 2 and the device 3, which volume V1 has a pressure P1 as described above, and a second volume V2 after the device 3, which volume V2 has a pressure P2. The pressure P1 will be higher in the volume V1 compared to the pressure P2 in the volume V2. FIG. 1C shows a schematic view of a system, which system, in addition to the flow inducer 2, device 3 having a changeable open area 4, the first sound capturing device M1, the system monitoring device 5, the database 6 and the first sound generating device S1 as described for the system shown in FIG. 1B above, further comprises a second sound capturing device M2.

The second sound capturing device M2 is preferably placed inside the closed pressurised unit 1 but can also be placed in the wall of the unit 1 or another appropriate place. The second sound capturing device M2 is placed before the device 3 in the flow direction of the system.

One purpose of the second sound capturing device M2 is to be able to detect and analyse a difference in pressure drop caused by the device 3. A pressure drop will always occur when the air moves from one part of the system to another, i.e., when the air leaves the flow inducer, when the air enters and leaves the device having an open area, when air flows through a dampener, valve, heat exchanger or any other component. This can be detected by measuring the sound variables on both sides of a device, in this case on both sides of the device 3. The first sound capturing device M1 will detect sound variables on one side of the device 3 and the second sound capturing device M2 on the other side and the difference can then be calculated (this is performed in the system monitoring device 5). The results show the differences in frequency bands as the pressure drop has changed across the device 3 with regard to the fact that sound variables can be changed in duct systems or in noisy environments. One effect of this is that it is possible to know if the change or deviation occurred before the device 3 or if the change or deviation is over the open area 4, or a combination of both. The second sound capturing device M2 makes it possible to achieve a more accurate value of the deviation or change in pressure drop. The second sound capturing device is also a part of the self-learning function of the system, described further below.

The second sound capturing device M2 could for example also be used to calibrate the system for background sound from a products local fan or from a pump or fan in a larger installation of ducts or pipes.

Pressure drops through the open area occurs in systems having gases, i.e. the pressure before the dampener, vent, filter will have a larger value before than after the open area, caused by a fan (gas/air).

As in the system described in FIGS. 1A and 1B the first volume V1 is situated between the flow inducer 2 and the device 3, which volume V1 has a pressure P1 as described above, and the second volume V2 after the device 3, which volume V2 has a pressure P2. The pressure P1 will be higher in the volume V1 compared to the pressure P2 in the volume V2. A system according to this embodiment, having a filter as device 3, can in combination with the first sound generating device S1 which emits sound before the device 3, not only eliminate sound (so called active noise reduction) but also test and diagnose which types of particles that have caused the pressure drop. This is described more in detail below with reference to FIG. 2A.

FIG. 1D shows a schematic view of a system, which system, in addition to the flow inducer 2, device 3 having a changeable open area 4, the sound capturing device M1, the system monitoring device 5, the database 6, the first sound generating device S1 and the second sound capturing device M2 as described for the system shown in FIG. 1C above, further comprises a second sound generating device S2.

The second sound generating device S2 can for example be a loudspeaker or other appropriate device to emit sound of different frequencies. The second sound generating device S2 is preferably placed inside the closed pressurised unit 1 but can also be placed in the wall of the unit 1 or another appropriate place. It is important to place the sound generating device S2 before the device 3 in the direction of the flow.

One specific purpose of the second sound generating device S2, within his embodiment, is to function as a noise-cancellation unit together with the first sound capturing device M1. The first sound capturing device M1, that is placed after the device 3 in the direction of the flow, register the sound variables of the sound when it leaves the device 3 and sends a signal to the second sound capturing device M2 to emit a specific sound so the tones can cancel each other out and the system becomes silent.

The second sound generating device M2 could also be used to analyse how and where the open area has been changed/polluted if it is filter etc. The second sound generating device could also be used to calibrate and analyse different parameters of the characteristic variables, such as temperature of the air.

FIG. 2A-2F shows different systems (or products) having at least one changeable open area, a flow inducer and at least one sound capturing device. These systems are shown as examples of systems where the method can be used and is not to be interpreted as the only examples or in any way limiting other combination of the different parts/devices included in the system and method as defined by the claims. The bold arrows included in these figures are intended to show the direction if the flow of gas within the system.

As in the system described in FIGS. 1A, 1B and 1C the first volume V1 is between the flow inducer 2 and the device 3, which volume V1 has a pressure P1 as described above, and a second volume V2 after the device 3, which volume V2 has a pressure P2. The pressure P1 will be higher in the volume V1 compared to the pressure P2 in the volume V2. FIG. 2A show a schematic view of one embodiment of a system comprising a flow inducer 2, a damper as the device 3 having a changeable open area 4 and a first sound capturing device M1. The system has a first volume V1, having a pressure P1, between the flow inducer 2 and the device 3, and a second volume V2, having a second pressure P2 after the device 3. The pressure P1 will be higher in the volume V1 compared to the pressure P2 in the volume V2 as described above with reference to FIG. 1A. This system can typically be used in a HVAC-system (heating, ventilation, and air conditioning-system). The air from the flow inducer passes through the damper having a changeable open area. Air will flow out of the system through the changeable open area of the damper. When the damper regulates the air flow out from the system the open area of the damper can be altered, either mechanically or manually by a user or a computer. The sound capturing device will detect changes and deviations to the system and send data to a system monitoring unit (not shown in the figure). In the embodiment shown in FIG. 2A the first sound capturing device M1 is placed after the damper in the direction of the air flow. The first sound capturing device M1 could also be placed before the damper, i.e. between the flow inducer 2 and the changeable open area 4. Placing the sound capturing device between the flow inducer and the damper will be less favourable since the sound capturing device will also detect noise from the flow inducer, but it will still be possible to detect changes and deviations in the system.

The damper can for example be a device having nozzles or other types of openings where at least the size of the openings can be changed mechanically either manually by a user or automatic/electronic by utilizing a motor/engine. The open area is in that case the total area of the open part of the nozzles, which changes when one of the parts are adjusted relative to the other. There are many types of nozzles and openings available on the market, and anyone of them could be used as long as it is possible to adjust the open area of the openings either manually or by using a motor to for example slide one part relative to the other. Other dampers or valves simply adjust the open area by turning a blade or reducing the area of the pipe or duct.

FIG. 2B shows a schematic view of a second embodiment of a system comprising a filter as the device 3 having a changeable open area 4, a flow inducer 2 and a first sound capturing device M1 placed after the filter and the flow inducer in the direction of the air flow. The system has a first volume V1, having a pressure P1, before the device 3, and a second volume V2, having a second pressure P2 after the flow inducer 2. The pressure P2 will be higher in the volume V2 compared to the pressure P1 in the volume V1 since the flow inducer will increase the pressure.

The sound capturing device M1 will detect changes and deviations within the system and send data to a system monitoring unit (not shown in the figure). The open area will change when the filter becomes more and more clogged during time. On the market, this product would typically be used in a local air product, such as an air purification unit.

In this embodiment, the changeable open area 4 is a filter, which filter can for example be a filter for the incoming air, an air filter for air conditioning devices or a filter that has been designed to be able to analyse the content of the air by letting the filter become clogged with air from a special environment or room. By using such a filter, it is possible to analyse both how much time it takes for the filter to be clogged and also what substances and/or constituents that are caught in the filter.

It is also known that particles of different sizes will affect the sound variables in different ways. Larger particles that are stuck in the filter will affect the sound variables in one way and smaller particles in another way. By monitoring the changes and deviations in sound variables it would be possible to know not only that the filter is getting clogged but also if it is a slow clogging of small particles or if bigger particles are stuck in the filter. In a system that often gets a clogged filter it would be advantageous to be able to analyse the clogging, possibly by using different types of filters and after a while remove them and analyse the content to learn that a specific change or deviation in the sound variables is due to a specific type or size of particle that are stuck in the filter.

The open area of the filter will be smaller when substances or constituents clogs or get stuck in the filter, and this is hence a natural change of the open area that occurs over time as air flows through the filter. To increase the open area in the filter it is necessary to clean the filter. This can be done by removing the filter manually and replace it or clean it.

It would also be possible to utilise the system having a filter in a medical device or breathing device to be able to know when the filter is clogged and by what.

FIGS. 2C-2F, described below, all comprises more than one device 3 and hence also more than one changeable open area 4. In the case where two devices and two changeable open areas are present in the same unit, the second device is referred to as 3′ and the second changeable open area as 4′. In the case where three the devices and three changeable open areas are present in the same unit; the second device is referred to as 3′ and the third as 3″; the second changeable open area is referred to as 4′ and the third as 4″. It is to be noted that each device and each open area has the same function, but they do not need to be identical to the other(s) devices and open areas of the system. As described below a first device can for example be a damper, the second a heat exchanger and a third a filter. It is also possible to have a system having for example three filter devices. The examples in FIG. 2C-2F are added to show that units can have more than one device 3 and therefore more than one changeable open area and the examples are not to be interpreted as limiting examples in any way.

FIG. 2C shows a schematic view of a third embodiment of a system according to the invention, which system comprises a flow inducer, a damper as the device 3, a sound capturing device M1 and a second device 3′ having a changeable open area 4′ in the form of a heat exchanger. The system has a first volume V1, having a pressure P1, between the flow inducer 2 and the device 3, and a second volume V2, having a second pressure P2 directly after the device 3, in the direction of the arrows in the figure, and a third volume V3, having a pressure P3 after the second volume V2, since the pressure will be affected by second device 3′. The pressure P1 will be higher than the pressure P2 which in turn will be higher than the pressure P3.

The sound capturing device M1 will be able to detect changes in the open area both in the damper and in the heat exchanger. The mixing of the air decreases if, for example, a heat exchanger becomes clogged with dust and the total air supplied to the room becomes smaller. It is thus possible both detect which of the open areas has changed even if only one sound capturing device is used in the system and method.

This type of system can typically be used in a HVAC product with induction and heat exchanger. The open area changes both in the damper and in the heat exchanger as described with reference to FIG. 2A regarding the damper above.

In this system there will be a second air flow coming in through the heat exchanger, which will also affect the monitoring of the system. The overall function of the system—to monitor changes and deviations—will however still work in the same way. As described above, the sound capturing device can be placed in different places. If placed between the flow inducer 2 and the damper, it will also detect noise from the flow inducer. If it is placed between the damper and the heat exchanger or after the heat exchanger it will detect noise from the heat exchanger. It will however still be able to detect changes and deviations in the system.

One advantage with this type of system, where a damper and a heat exchanger are combined, is the ability to be able to control dampers and check the function of the heat exchanger. It makes it possible to regulate the climate in the room if needed. If the heat exchanger is clogged, the flow can for example be increased so that the function of the heat exchanger remains the same as before clogging.

FIG. 2D shows a schematic view of a fourth embodiment of a system according to the invention, which system comprises a filter as a first device 3 having a changeable open area 4, a flow inducer 2, a damper as a second device 3′ having a changeable open area 4′ and a sound capturing device M1 placed after the damper 3′ in the direction of the air flow. This type of system can for example be a local air product with a damper, such as for example an air purification unit comprising a damper.

The system has a first volume V1, having a pressure P1, before the first device 3 and the flow inducer 2, a second volume V2, having a second pressure P2 directly after the flow inducer 2, and a third volume V3, having a pressure P3 after the second device 3′. The pressure P2 will be higher than the pressure P1, since the flow inducer will increase the pressure, and the pressure P3, in the third volume will be lower than the pressure P2.

In this system two devices 3,3′ having changeable open areas 4,4′ are used, a filter and a device having nozzles/openings for the air to flow through (a damper in this case but could be any type of device having a changeable open area and capable of regulating the air flow). The open areas are independent of each other, in the sense that the openings of the damper can be regulated without affecting the open area of the filter and a clogging of the filter does not affect the open area of the openings in the damper.

The sound capturing device M1 will be able to detect any changes and deviations in the air characteristic values, by continuously, or at different time intervals, collecting data and send to the system monitoring device (not shown) to see if there is any change or deviation in the system.

The combined, synergistic effect of this is that it is possible to achieve a more effective monitoring of the system. If for example the filter device is clogged and the air flow/air volume is measured without taking into account that the filter can be clogged, the effect out of the device will be reduced without the user knowing about it.

FIG. 2E shows a fifth embodiment of a system according to the present invention, wherein three devices 3, 3′, 3″ having changeable open areas 4, 4′, 4″ are used, a filter, followed by a heat exchanger and a damper placed after the flow exchanger. A sound capturing device is placed in the system to detect changes and deviations in the air characteristic values as described above. This system can typically be used in a local climate product such as an air condition unit.

In this system two changeable open areas 4, 4′ are placed directly after each other. If the filter is placed before the nozzles in the direction of the air flow, as in this case, a clogged filter will however affect the magnitude of the air that can pass through the nozzles. A clogged filter will require the flow inducer to work harder and less air passes through changeable open areas. The filter will however in this case protect the heat exchanger from particles.

The system has a first volume V1, having a pressure P1, between the first device 3 and the second device 3′, a second volume V2, having a second pressure P2 directly after the flow inducer 2, and a third volume V3, having a pressure P3 after the third device 3″. The pressure P2 will be higher than the pressure P1, since the flow inducer will increase the pressure, and the pressure P3, in the third volume will be lower than the pressure P2.

FIG. 2F shows a sixth embodiment of a system according to the present invention, wherein three devices 3, 3′, 3″ having changeable open areas 4, 4′, 4″ are used, a filter in the beginning, a heat exchanger after the flow inducer in the direction of the airflow and thereafter a damper. A sound capturing device is placed after the damper but can also be placed in other parts of the system to detect changes and deviations in the air characteristic values in the system. This system can typically be used in a local climate product such as an air conditioning unit having an alternative design as compared to the system above.

The system has a first volume V1, having a pressure P1, after the second device 3′, and a second volume V2, having a second pressure P2 after the third device 3″. The pressure P1 will be higher in the volume V1 compared to the pressure P2 in the volume V2. Advantages with this type of system is for example that the open area of filters and service life of filters can be detected. The degree of clogging of the heat exchanger can be detected as well as function of dampers. If any of these three have changed for no known reason, they are reasons for increased energy consumption and reduced function of cooling or heating. This system can detect the deviations, send out a signal so that the problem can be fixed, the function restored, and the energy consumption can remain at a low level.

It is to be noted that the systems shown in the figures of this application is only examples. It is possible to combine the different parts in many different ways. The components inside the pressurised unit 1 can be placed and combined in any order. As described above (and below) it is preferred to have the sound capturing device placed in close proximity after the open area, but both the system and method will function also when the sound capturing device is placed in other places. Other placement of the sound capturing device require more sources for the database to compare the reference sound with to be able to monitor changes or deviations of sound variables caused by pressure drop in the system. The different parts can also be changed between the systems shown in the FIGS. 2A-2F, all falling within the scope of the present application.

All components that are placed in the system will affect the flow of air inside the system, and hence the air characteristic values. The more sound capturing devices used the more details can be extracted from the system and the diagnosis will be more accurate in determining where in the system the change or deviation occurred, since each sound capturing device will give one measuring point. In many cases however, one sound capturing device can be enough to detect a change or deviation in the system.

All of the systems above can further be provided with one or more sound generating devices as described with reference to FIGS. 1A-D above.

The present invention further relates to a method for monitoring and analysing a change of sound variables in a system, which system comprises at least one closed pressurised unit 1, which closed pressurised unit in turn comprises a flow inducer 2, at least one device 3 having a changeable open area 4 and at least one sound capturing device M1, a system monitoring device 5 and a database 6, which database comprises stored reference values of sound variables, which database further comprises values of characteristic variables and/or open area corresponding to the stored reference sounds.

The flow inducer 2 and the at least one sound capturing device M1 is preferably provided on each side of the device 3 to give more accurate values, but the method will work also when they are placed on the same side as described with reference to the system above.

The method for monitoring the sound variables in the system is shown as a flow chart in FIG. 3, wherein the sound capturing device M1 detects one or more sound variables in the unit (the unit can for example be a unit as shown in any of the FIGS. 1A-1D, 2A-2F or similar systems but is not limited to the units shown within this application). The detected sound variable(s) is sent to the system monitoring device 3 which will compare in the database if the detected sound variable(s) correlates with stored reference sounds in the database, i.e. if the detected sound variable corresponds with the expected sound variable(s) at the flow currently used. As described above relating to the system, the system monitoring device continuously monitors the flow out of the flow inducer and the pressure inside the closed pressurised unit. In this embodiment, the database returns a positive response, i.e., the value of the sound variable(s) is found in the database and the system is functioning as expected. As mentioned above, the database comprises different values for characteristic variables and is able to return data of both open area and characteristic variables back to the system monitoring device. The system itself could be installed in different products and solutions connected to an architecture of other systems.

In this first embodiment, the sound capturing device M1 is used to listen to the sound variables inside the closed pressurised unit 1 and to detect when something in the sound variables changes, based on stored values in the database connected to the volume before and after the device 3 and further how the open area 4 has changed.

If the detected sound variable(s) does not correlate with the stored reference sound, the database will instead return a negative response.

The method according to this embodiment comprises the following steps:
i. the sound capturing device M1 detects sound variables in the closed pressurised unit 1,
ii. the detected sound variables is emitted by the sound capturing device M1 to the system monitoring device 5;
iii. the system monitoring device 5 receives the sound variables and compare it to the stored reference sounds in the database 6; and
iv. the database 6 returns a positive response to the system monitoring device 5 if the detected sound variables correspond to stored reference values of sound variables and a negative response to the system monitoring device 5 if the detected sound variables deviate from the stored reference values of sound variables in the database.

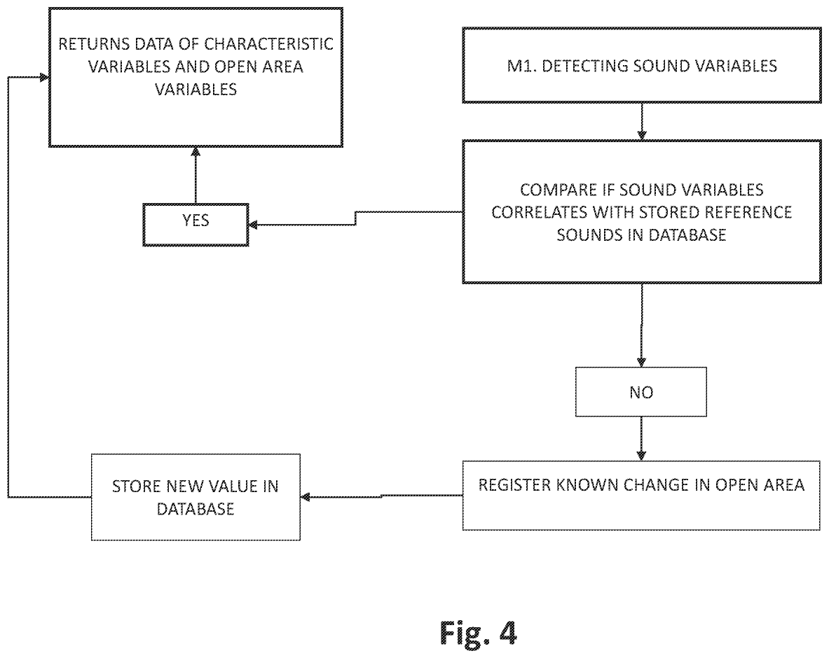

In most cases only monitoring the frequency of the sound variables would not be enough, one would also like to analyse when a change or deviation in sound variables appears and possibly also be able to modify the database with more information when a change or deviation is detected. This analyse can be done in several steps, which are shown in FIG. 4-10 and are described in more detail below. In each step the system monitoring device asks the database if the value is a known value (a positive response) or an unknown value (a negative response). The response is returned to the system monitoring device, which will either decide that the value(s) is to be stored or to do further analysing steps, as described further below.

In FIG. 4, a flow chart of another embodiment of the method is show, wherein the sound capturing device M1 detects sound variables in the system. The sound variables are sent to the system monitoring device 5 which will compare if the s detected sound variables correlate with/correspond to the expected sound variable at the flow currently used, i.e. the stored reference sound variables in the database. In this rather simple method, the monitoring device will check if there is any change in sound variables or of the open area. If a change of the sound variables has occurred and the flow is still the same, the monitoring device will assume that the change of sound variables is due to a change of the open area and store the changed sound variables (referred to as new value in FIG. 4) together with the flow and the value of the open area in the database. If the database does not find the detected sound in the database, it will return a negative response:
v. the system monitoring device analyses if the open area 4 has been changed and returns a positive response if the open area has been altered and a negative response if the open area has not been altered.

If the response to the question regarding change of open area is positive, the detected sound variables will be stored in the database together with the value of the open area (if known) and the values of the detected sound variables. As described above, the open area can for example be a filter device, a heat exchanger, a valve or a device having nozzles or other type of openings to regulate the direction or magnitude of a flow of air. If the open area is a filter device or a heat exchanger, the change of open area will occur if anything is clogging at least a part of the filter or heat exchanger. If the open area is a device used to regulate the direction or magnitude of flow out of the system, the open area will change if a user or a monitoring device changes the number of openings, the size of the openings or the like mechanically. The method can then also further check if any of the characteristic variables in the unit has changed.

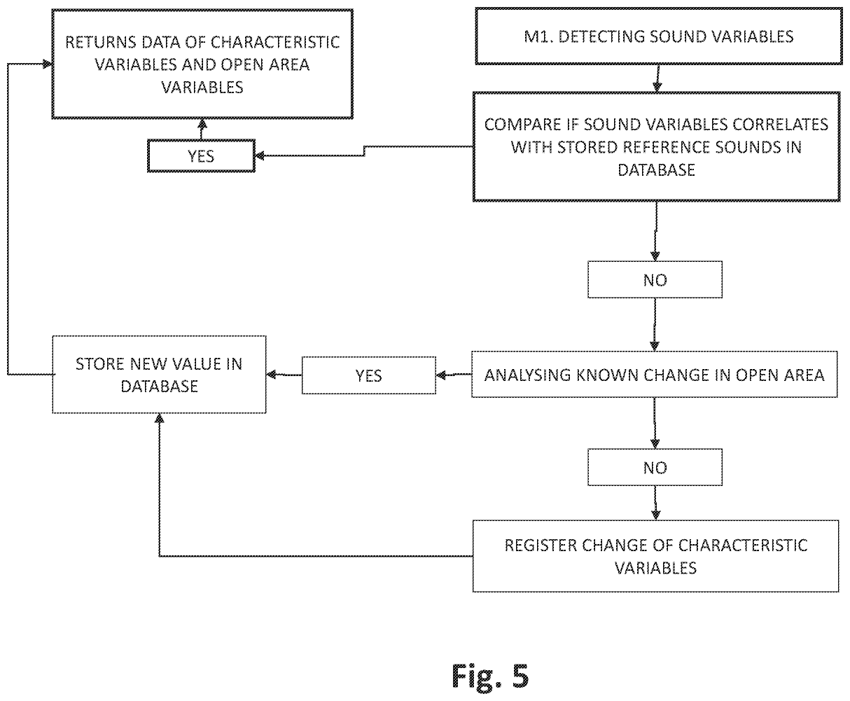

If the response to the question if the open area has changed is negative, as shown in FIG. 5, the method will, in this simple system, register the change of the characteristic variables and the value of the open area as new values in the database. The database will thereafter return the values to the system monitoring device as known values, so that the system monitoring device will have the values saved for the future.

As mentioned above, the characteristic variables before the open area are for example changed if the magnitude of the flow out of the flow inducer is changed. This can be done either manually or automatically for example according to a schedule entered into the monitoring unit as described above where the system is described. If the response to the question (regarding change of any of the characteristic values before the open area) is positive, the detected sound variables will be stored in the database together with the value of the open area (if known) and the measured characteristic values. The characteristic variables can also be changed if for example a filter is clogged, dampers or valves are clogged or changed, the pressure or any other variable is changed. The system can either check one specific characteristic variable or a set of chosen characteristic variables. This is set in advance in the monitoring device for each specific system and can be changed by a user or any other monitoring system used for this purpose.

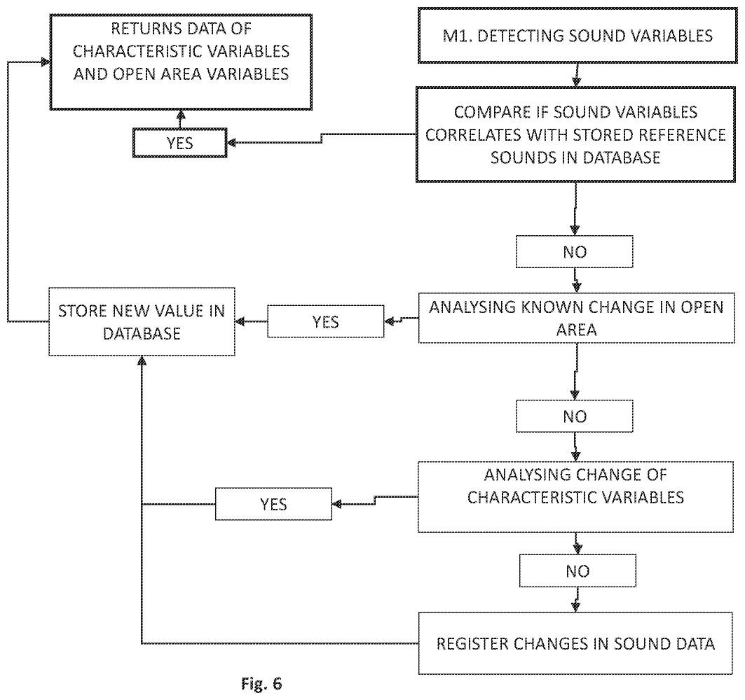

In a further step, shown in FIG. 6, the method will:
vi. analyse if any of the characteristic variables has been changed and returns a positive response to the system monitoring unit 5 if any of the characteristic variables have been altered and a negative response if none of the characteristic variables have been altered.

In this step, the method knows that the open area has not changed and will therefore move on to analyse if any of the characteristic variables have changed before, over or after the open area in the direction of the flow.

If the response to the question if the flow has changed is negative, the method will move on to the next step:
vii. checking the value of the altered sound variables and store it in the database together with a value for the open area and the characteristic variables; or
viii. checking the value of the altered sound variables and sending a signal to a user, a system monitor, a building management system, a screen or other device capable of receiving the signal that there is a deviation and give the possibility to manually store the altered sound variables together with a reason for the deviation.

In this step, the system monitoring device will, in addition to what has been described with reference to any of FIGS. 3-5 above, register the change (deviation) of sound variables together with the value of the open area (if known) and the measured air characteristic variables, which is also shown in the flow chart in FIG. 6. In this case, the reason for the deviation is not known, but the system stores the value as an unknown change and remembers the values of the sound variables, the characteristic variables, and the open area (if known). An optional step can be added where the system monitoring device sends a signal to a user, a system monitor, a building management system, a screen or the like (any other device capable of receiving the signal) to notify that there is a deviation in the sound variables of the system. The signal can for example be a text message, a warning, an alarm or any other appropriate signal.

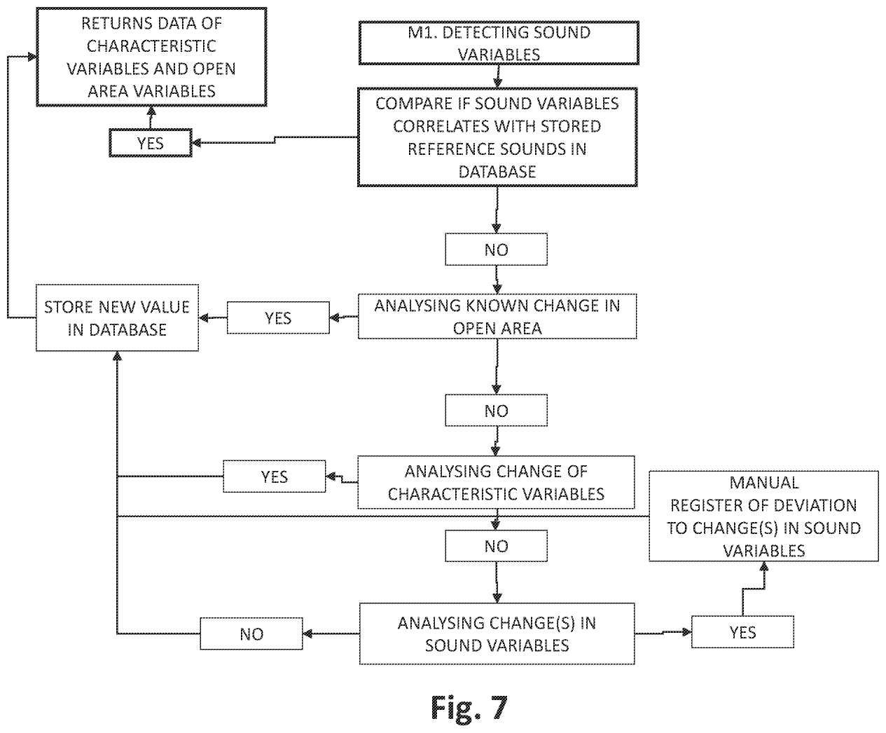

FIG. 7 shows a flow chart of yet another embodiment of the method, comprising also all the steps described above with reference to FIGS. 3-6, where the changes of the sound variables that was detected as unknown in the previous step will be analysed further manually by a third part (user or computer) and the values of the sound variables, the characteristic variables, and the open area (if known) will be stored in the database, as new values, together with a reason for the deviation. In this way, the database will know the reason for the deviation if it occurs again and can either send a signal that there is a deviation also the next time, or if the reason for the deviation was not a reason for sending out a signal it can be inserted into the database as a known value that does not need any alert signal sent out.

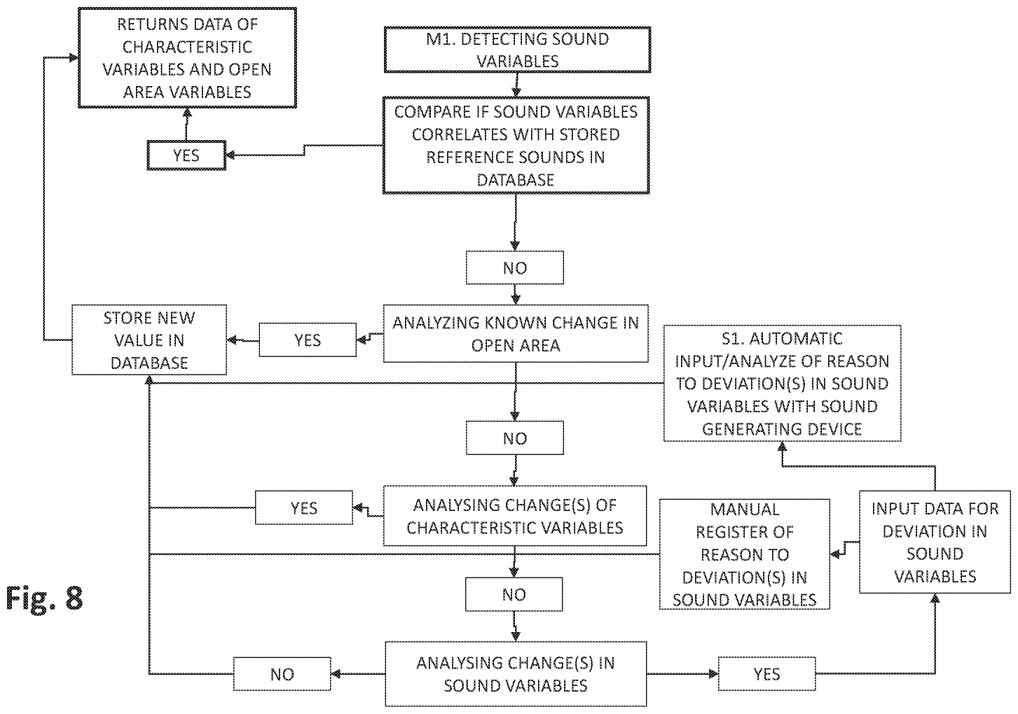

FIG. 8 shows a flow chart of a further embodiment of the method, wherein the system that is monitored using the method has been provided with a first sound generating device S1. The method in FIG. 8 is able to perform all the steps previously described and will further perform the following step:
ix. analysing the reason for the deviation by generating a sound using the first sound generating device S1 and detecting the sound in the first sound capturing device M1 and storing the value of the characteristic variables, the open area and the sound variables in the database together with the reason for the deviation.

In this way the system will be able to automatically analyse the reason for a deviation in sound variables by using the first sound generating device S1, which will send a sound wave through the system, which is detected by the sound capturing device, a so-called ping sound. The function related to the sound generating device S1 can be used in any of the previous steps, i.e., it can be used to ping sound to analyse changes in any characteristic values, changes in the open area(s) or in the sound variables. This can hence also be used for a known change if more detailed information is needed. If the sound generating device S1 have been provided in the system when installed, it is likely that the user would like to utilise the function in all steps. The ping sound can be used temporarily for analysing or continuously to amplify a sound image that is faint or indistinct.

The system also makes it possible for manual input data for deviance in the sound variable(s). This could be useful when the system cannot find the reason for the deviance on its own.

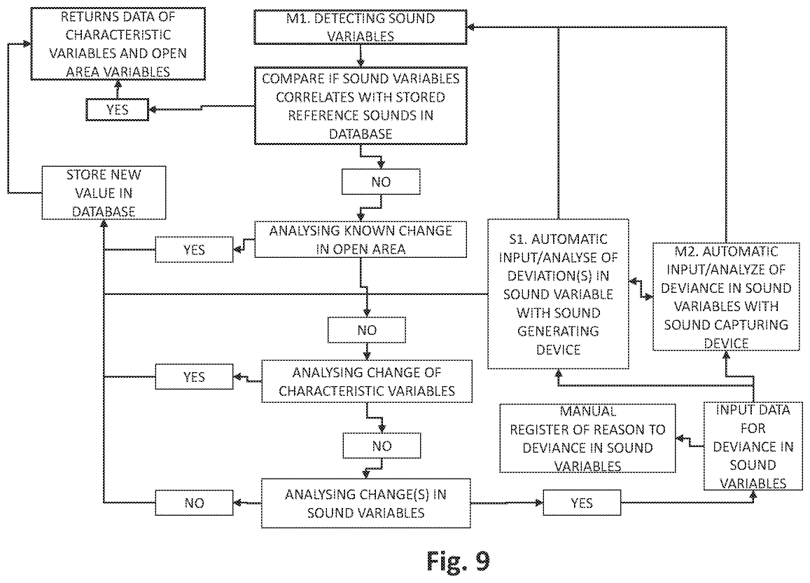

The method as described in FIG. 8 can further be enhanced by using a second sound capturing device M2 in the system, as shown in FIG. 9. In this embodiment the first sound capturing device M1 is provided on one side of the device 3 and the second sound capturing device M2 is provided on the other side of the device 3. When the change in sound variables is unknown it is called a deviation and, as described with reference to FIG. 6, the reason for the deviation can be analysed manually as described with reference to FIG. 7. However, it can also be enhanced by utilizing the second sound capturing device M2 as shown in FIG. 9, according to the following step:
x. analysing the deviation of sound variables before and after the at least one changeable open area and calculating the difference in sound variables between the first sound capturing device M1 and the second sound capturing device M2 and automatically storing the value of the sound variables, the characteristic variables and the open area and in the database together with the reason for the deviation.

The result of this analysis will be sent to the database and be stored, either alone or together with a manual input of reason for the deviation, together with the changed sound variables and the value of the open area (if known). The difference in sound variables from the first sound capturing device M1 and the second sound capturing device M2 can then be calculated. The benefits of using a first sound generating device S1 and a first and a second sound capturing device M1, M2 in the system is combined to further increase the accuracy of the analysis.

As mentioned above, the use of more than one sound capturing device will give more accurate values, because the system is provided more than one measuring point. However, the system and method work with only one sound capturing device, since the mixing of the air decreases if, for example, a heat exchanger becomes clogged with dust and the total air supplied to the room decreases. It is thus possible both detect which of the open areas has changed even if only one sound capturing device is used in the system and method.

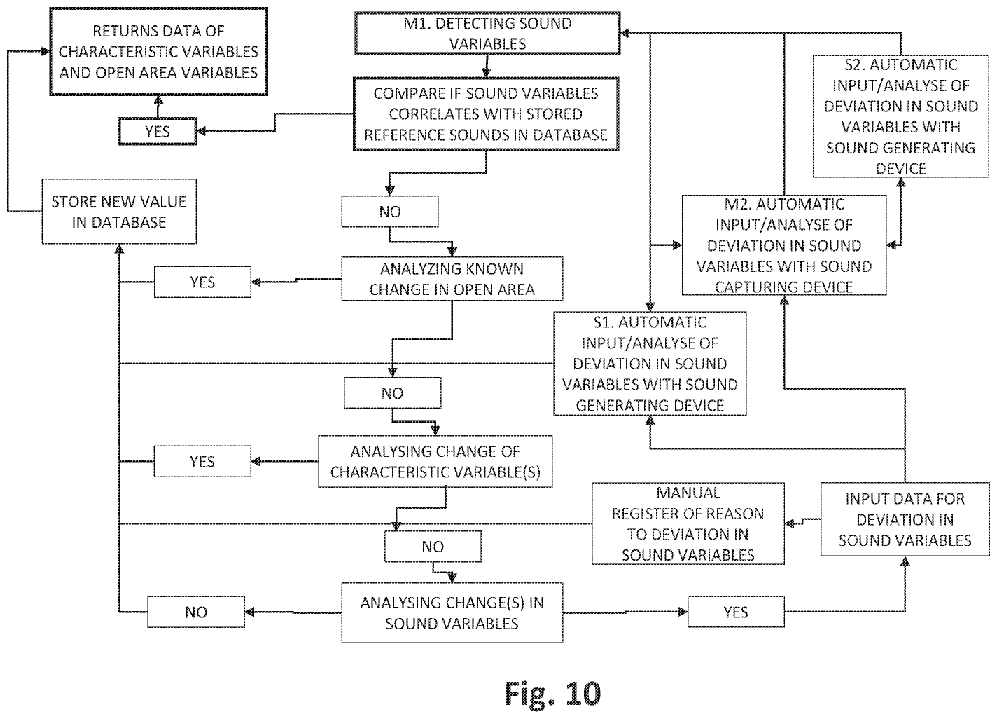

FIG. 10 shows a further embodiment of the method, wherein the system as described before has further been provided with a second sound generating device S2, wherein the first sound generating device S1 is provided on one side of the at least one device 3 and the second sound generating device S2 is provided on the other side of the at least one device 3. The method in FIG. 10 is able to perform all the steps previously described and will further to perform the following additional step:
xi. generating a sound in S1 and generating a sound in S2 and comparing the sound in the sound capturing devices M1 and M2 to further increase the accuracy of the analysis performed in the system monitoring unit 5.

Although a specific order of the steps has been shown in this application, it is possible to combine the steps described above in several different orders and be used both for detection of changes and deviations within the pressurised unit. Especially step ix. as described above can be performed as an additional step together with any of the other steps.

Additional information can be used to detect patterns of the open area in one or more air filters. Different deviations of the open area cause different sounds with the same characteristic variables before and after the open area. The system can therefore be used to detect where deviations is positioned in filter such as different patterns of items clogging the opening area or areas.

It is likely that if the system has been provided with a first sound generating device and a first sound capturing device, the user would like to use the system to analyse the reason for the change, even if not all of the other steps of the methods are performed.

All of the methods described above can also be provided with an additional step to indicate a negative response by sending a signal to a user, a building management system, a computer, a screen or other device capable of receiving the signal to notify that there is a deviation in the sound variables of the system.

It is a further advantageous that the system can send a notification to a user/monitoring device that the filter will need to be replaced or cleaned within a certain time frame in order to maintain the efficiency of the system.

The system and method as presented in this application gathers many functions in one and the same solution using only one measuring point (sound capturing device). This has the advantages that it is possible to detect changes in the variables before and after the open area and the open area itself, all of them together or individually. The method can be used in any type of system having a pressurised volume before or after an open area, which open area is changeable. It can be used in both gaseous systems and fluid-based systems.

A further advantage of this method is that it can return more than one deviation (unknown value) at the same time.

The method according to the present invention also have the advantage that it is possible to monitor different characteristic values in multiple places in the system, by using multiple sound capturing devices and, if needed, one or more sound generating devices.

As mentioned above, the monitoring device and the database can be connected to more than one pressurised unit. The system monitoring device can comprise more than one database. In a larger system it would be possible for the monitoring device to search in databases from several pressurised units to find the requested data.

The system can comprise more than one closed pressurised system. The collected data can be stored together in one large database or in one database for each pressurised unit, depending on the intended use of the stored data.

The system and method as described herein is of particulate interest in ventilation systems, but could also be used in other systems as recognised by the person skilled in the art.

1. A system for monitoring and analyzing a change or deviation of sound variables within a closed pressurized unit, which system is a system for distribution of gaseous components and comprises:
at least one closed pressurized unit, which closed pressurized unit comprises a flow inducer, at least one device having at least one changeable open area, and at least one sound capturing device;
a system monitoring device having a database including stored reference values for sound variables, and values of characteristic variables associated with the gaseous components in the system and/or the changeable open area corresponding to the stored reference values for sound variables, which system monitoring device is able to receive values of sound variables and characteristic variables and compare them to the stored values in the database; and
a second sound capturing device, wherein the first and second sound capturing devices are provided on different sides of the at least one device.

2. The system of claim 1, wherein the flow inducer and the at least one sound capturing device are provided on different sides of the at least one device.

3. The system according to claim 1, wherein the system further comprises at least one sound generating device configured to emit sounds with different frequencies.

4. (canceled)

5. The system of claim 3, wherein the system comprises two sound generating devices, and wherein a first sound generating device and a second sound generating device are provided on different sides of the at least one device.

6. The system of claim 1, wherein the at least one changeable open area of the at least one device is changed mechanically.

7. The system of claim 1, wherein the system comprises at least two devices, each having at least one changeable open area.

8. The system of claim 1, wherein the gaseous component is air.

9. A method for monitoring and analyzing a change or deviation of sound variables in a system, which system comprises:
at least one closed pressurized unit, which closed pressurized unit comprises a flow inducer, at least one device having a changeable open area and at least one sound capturing device;
a system monitoring device having a database, including stored reference values of sound variables, and values of characteristic variables and/or the changeable open area corresponding to the stored reference values of sound variables;
the method comprising:
i. detecting, by the sound capturing device, sound variables in the closed pressurized unit;
ii. emitting, by the sound capturing device, the detected sound variables to the system monitoring device;
iii. receiving, by the system monitoring device, the detected sound variables and comparing them to the stored reference values of sound variables in the database; and
iv. returning, by the database, a positive response to the system monitoring device in response to the detected sound variables corresponding to stored reference values of sound variables and a negative response in response to the detected sound variables deviating from the stored reference values of sound variables in the database.

10. The method of claim 9, further comprising:
v. in response to the database returning a negative response in step iv, analyzing, by the system monitoring device in response to the changeable open area having changed, and returning a positive response in response to the changeable open area having changed and a negative response in response to the changeable open area not having changed.

11. The method of claim 9, further comprising: in response to the database returning a positive response in step iv, checking, by the system monitoring unit, the value of the changeable open area, and storing the value in the database together with the values of the detected sound variables.

12. The method of claim 10, further comprising: checking, by the system monitoring unit, whether any of the characteristic variables in the unit have changed.

13. The method of claim 10, further comprising:
vi. in response to the database returning a negative response in step iv, analyzing whether any characteristic variables have changed or been altered, and returning a positive response to the system monitoring unit in response to any of the characteristic variables having changed or been altered and a negative response in response to none of the characteristic variables having changed or been altered.

14. The method of claim 13, further comprising: in response to a positive response being returned from the database, checking, by the system monitoring unit, the value of the altered characteristic variables and storing them together with the value of the detected sound variables and the value of the changeable open area in the database.

15. The method of claim 13, further comprising: in response to a negative response being returned from the database, performing, by the system monitoring unit, one of the following steps:
vii. checking the value of the altered sound variables and storing them in the database together with a value for the changeable open area and the characteristic variables; or
viii. checking the value of the altered sound variables and sending a signal to a user, a system monitor, a building management system, a screen or another device capable of receiving the signal that there is a deviation and enabling manual storing of the altered sound variables together with a reason for the deviation.

16. The method of claim 15, wherein the system further comprises a first sound generating device between the air flow inducer and the changeable open area, and wherein the system monitoring unit performs the following step subsequent to step viii:
ix. analyzing a reason for the deviation by generating a sound using the first sound generating device, detecting the sound in the sound capturing device, and storing the value of the characteristic variables, the changeable open area and the sound variables in the database together with a reason for the deviation.

17. The method of claim 16, system monitoring unit performs the following step:
x. analyzing the change of sound variables before and after the at least one changeable open area and, calculating the difference in sound variables between the first sound capturing device and the second sound capturing device, and automatically storing the value of the sound variables, the characteristic variables and the changeable open area and in the database together with the reason for the deviation.

18. The method of claim 17, wherein the system further comprises a second sound generating device, wherein the first and second sound generating devices are provided on different sides of the at least one device, further comprising:
xi. generating a sound in the first sound generating device, generating a second sound in the second sound generating device, and comparing the sound in the first sound capturing device and the second sound capturing device.

19. The method of claim 9, further comprising: indicating a negative response by sending a signal to a user, a building management system, a computer, a screen or other device capable of receiving the signal to provide a notification about a deviation in the sound variables of the system.
